(19) United States
(12) Patent Application Publication
(10) Pub. No.: US 2024/0235034 A1
(43) Pub. Date: Jul. 11, 2024

(54) ANTENNA DEVICE, RADAR DEVICE AND VEHICLE CONTROL SYSTEM

(71) Applicant: Sony Semiconductor Solutions Corporation, Kanagawa (JP)

(72) Inventors: Yudai Takahashi, Kanagawa (JP); Yasuhiro Okada, Kanagawa (JP)

(21) Appl. No.: 18/262,825

(22) PCT Filed: Jul. 19, 2022
(86) PCT No.: PCT/JP2022/028096

§ 371 Date: Jul. 25, 2023

(30) Foreign Application Priority Data
Aug. 2, 2021 (JP) 2021-126773

(51) Int. Cl. H01Q 9/04; B60W 60/00; G01S 7/03; G01S 13/931; H01P 3/08; H01Q 1/32; H01Q 1/48

(52) U.S. Cl. CPC H01Q 9/0457; G01S 7/03; G01S 13/931; H01P 3/081; H01Q 1/3233; H01Q 1/48; B60W 60/001; B60W 2420/408

(57) ABSTRACT

An antenna device including a dielectric substrate, a power supply line, a waveguide, a first antenna element, and a second antenna element. The power supply line is disposed on a first surface of the dielectric substrate. The waveguide is configured to transmit a signal fed from the power supply line in the dielectric substrate. The first antenna element is disposed on a second surface of the dielectric substrate and is configured to receive the signal supplied from the waveguide by a first proximity coupling. The second antenna element is disposed on the second surface of the dielectric substrate and is configured to receive the signal supplied from the waveguide by a second proximity coupling.

### CROSS REFERENCE TO RELATED APPLICATIONS

This application claims the benefit of Japanese Priority Patent Application JP 2021-126773 filed on Aug. 2, 2021, the entire contents of which are incorporated herein by reference.

### TECHNICAL FIELD

The present disclosure relates to an antenna device, a radar device and a vehicle control system.

### BACKGROUND ART

As frequencies used in an in-vehicle radar, a 76 to 77 GHz band is mainly used for long distance detection and a 24 GHz band is mainly used for short distance detection. Although a frequency band for short range detection has a wide frequency bandwidth and high range resolution, there is a power limit and thus the transition to the 77 to 81 GHz band is planned. In this case, the 76 to 77 GHz band for long distance detection and the 77 to 81 GHz band for short distance detection after the transition are continuous frequencies and an integrated circuit (IC) chip which covers a 5 GHz width of 76 to 81 GHz is also provided.

However, an antenna corresponding to such an IC chip has a complicated structure and a low degree of freedom in design. Therefore, the manufacturing cost increases.

### CITATION LIST

### Patent Literature

PTL 1: Patent Document 1: JP 2011-220690 A

### SUMMARY

### Technical Problem

The present disclosure was made in view of the above-described problems and the present disclosure have recognized to provide a wideband antenna device and a radar device having a simple structure.

### Solution to Problem

An antenna device of the present disclosure includes a dielectric substrate, a power supply line, a waveguide, a first antenna element, and a second antenna element. The power supply line is disposed on a first surface of the dielectric substrate. The waveguide is configured to transmit a signal fed from the power supply line in the dielectric substrate. The first antenna element is disposed on a second surface of the dielectric substrate and is configured to receive the signal supplied from the waveguide by a first proximity coupling. The second antenna element is disposed on the second surface of the dielectric substrate and is configured to receive the signal supplied from the waveguide by a second proximity coupling.

### BRIEF DESCRIPTION OF DRAWINGS

FIG. 1 is a block diagram of an antenna device according to an embodiment of the present disclosure.

FIG. 2 is a view of the antenna device when viewed from the back surface.

FIG. 3 is a perspective view illustrating a part of a layer of an antenna device in a transparent manner.

FIG. 4 is a perspective cross-sectional view illustrating a part of the antenna device from a back surface side.

FIG. 5 is an enlarged perspective view illustrating a surface of the antenna device.

FIG. 6 is a partial cross-sectional view of the antenna device of FIG. 5.

FIG. 7 is a diagram of a measured reflection intensity of a signal fed to an antenna.

FIG. 8 is a diagram of a radiation pattern of an antenna with base power feeding.

FIG. 9 is a diagram of a radiation pattern of an antenna with central power feeding.

FIG. 10 is a diagram illustrating an example of an antenna device according to a first modification.

FIG. 11 is a diagram illustrating an example of an antenna device according to a second modification.

FIG. 12 is a diagram illustrating an example of an antenna device according to a third modification.

FIG. 13 is a diagram illustrating another example of an antenna device according to the third modification.

FIG. 14 is a block diagram of a radar device according to an embodiment of the present disclosure.

FIG. 15 is a block diagram illustrating a configuration example of a vehicle control system.

FIG. 16 is a diagram illustrating an example of a sensing region.

### DESCRIPTION OF EMBODIMENTS

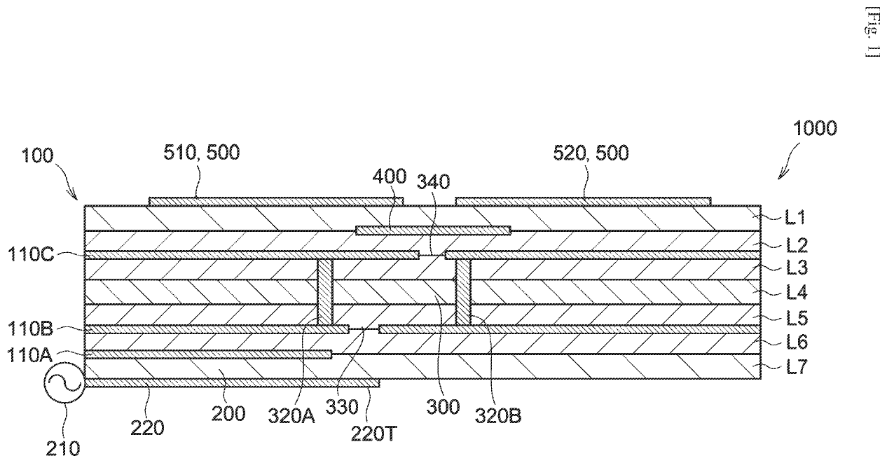

FIG. 1 illustrates a block diagram of an antenna device 1000 according to an embodiment of the present disclosure. The antenna device 1000 includes a dielectric substrate (substrate) 100 including a plurality of layers, a power supply line (supply line) 200, a waveguide 300 which transmits a signal fed from the power supply line 200 from a back surface side to a front surface side of the dielectric substrate 100, a power feeding unit 400 which feeds power to the antenna by proximity coupling on the basis of the signal transmitted by the waveguide 300, and an antenna 500 which radiates a radio wave on the basis of the signal fed from the power feeding unit 400.

The dielectric substrate 100 includes a plurality of layers L1 to L7. A front surface (surface on a substrate lower side) of the layer L7 corresponds to a first surface of the dielectric substrate 100 and a front surface (surface on a substrate upper side) of the layer L1 corresponds to a second surface of the dielectric substrate 100. The layer L1 and the layer L7 include, for example, a fluorine substrate or a glass polyimide substrate. The layers L2, L3, L4, L5, and L6 include a high frequency material such as a glass epoxy substrate.

A power feeding unit 400 is provided between the layers L1 and L2. The power feeding unit 400 is, for example, a plate-shaped conductive member. The conductive member is, for example, a metal such as copper, aluminum, or gold (the same applies hereinafter). The power feeding unit 400 feeds a signal supplied from the waveguide 300 which will be described later to the antenna 500 by proximity coupling.

Ground plates 110B that are conductive members are provided between the layers L5 and L6 on the left and right sides at an interval of an opening 330 in a direction parallel to the substrate surface. Ground plates 110C that are conductive members are provided between the layers L2 and L3 on the left and right sides at an interval of an opening 340 in a direction parallel to the substrate surface.

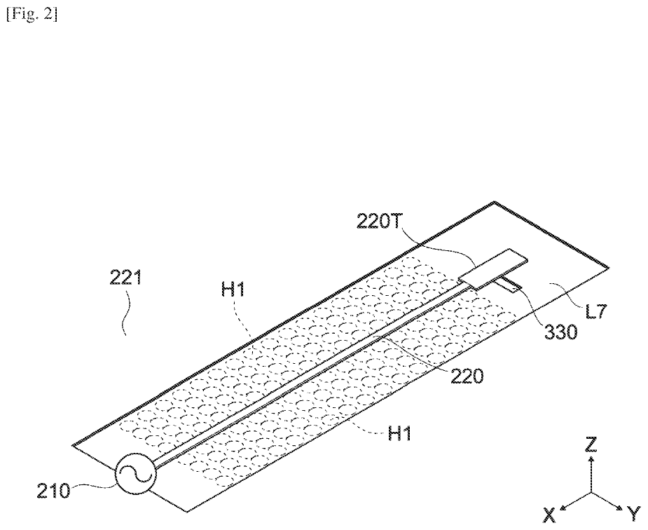

A ground plate 110A that is a conductive member is provided between the layers L6 and L7. The ground plate 110A functions as a ground line of the power supply line 200. The power supply line 200 is a microstrip line. The ground line (ground plate 110A) and the ground plate 110B on the left side may be connected or coupled by one or a plurality of vias via the layer L6 (refer to a via H1 in FIG. 2 which will be described later).

A via 320A which passes between the layers L3 and L5 and electrically connects the left ground plates 110B and 110C is provided. A via 320B which passes between the layers L3 and L5 and electrically connects the right ground plates 110B and 110C is provided.

A part on the upper side of a region disposed between the via 320A and the via 320B is covered with the ground plate 110C on the left side and the ground plate 110C on the right side, and the remaining part is the opening 340. A part on the lower side of the region disposed between the via 320A and the via 320B is covered with the ground plate 110B on the left side and the ground plate 110B on the right side, and the remaining part is the opening 330. Although the positions of the openings 330 and 340 are different in the lateral direction on the paper surface of FIG. 1, they may be the same or partially overlap. The via 320A, the via 320B, the ground plate 110C on the left side, the ground plate 110C on the right side, the ground plate 110B on the left side, and the ground plate 1101B on the right side constitute a waveguide 300 (in-substrate waveguide).

One of the opening 330 and the opening 340 corresponds to an input unit of the waveguide 300 and the other corresponds to an output unit of the waveguide 300. Specifically, in the case in which this antenna device is used for transmission, the opening 330 corresponds to an input unit and the opening 340 corresponds to an output unit, and when this antenna device is used for reception, the opening 340 corresponds to an input unit and the opening 330 corresponds to an output unit. In the following description, it is mainly assumed that the opening 330 corresponds to the input portion of the waveguide 300 and the opening 340 corresponds to the output portion of the waveguide 300.

The antenna 500 is provided on the surface of the layer L1. The signal line 220 of the power supply line 200 is disposed on the lower front surface (back surface) of the layer L7. The signal line 220, the ground line 110A, and the layer L7 (dielectric layer) constitute the power supply line 200. A power supply circuit 210 which supplies a high-frequency signal (a signal in a millimeter wave band in the embodiment) is connected to the power supply line 200. The power supply circuit 210 is configured by, for example, an integrated circuit. Although the power supply line 200 is a microstrip line in the embodiment, other lines such as a coplanar line are also possible.

The power supply line 200 transmits a signal in the millimeter wave band supplied from the power supply circuit 210. An end 220T of the power supply line 200 faces the opening 330 via the layer L7 and the layer L6. A signal transmitted through the power supply line 200 is input from the end 220T to the waveguide 300 via the opening 330. In this manner, backside power supply in which power is fed from a surface opposite to a surface on which the antenna 500 is disposed is performed.

FIG. 2 is a partially enlarged view of the antenna device 1000 when viewed from the back surface. As an example, the signal line 220 is formed by patterning a conductor foil (copper foil or the like) on the surface of the dielectric substrate (layer L7). More specifically, the entire surface of the dielectric substrate (layer L1) is covered with the conductor foil 221 (not illustrated in FIG. 1) and the region in which the power supply line 200 is formed is patterned to form the signal line 220. Ends of the signal line 220 and the ground line 110A are connected to the power supply circuit 210. The end 220T of the signal line 220 opposite to the power supply circuit 210 faces the opening 330 of the waveguide 300 in a thickness direction of the substrate. A plurality of cylindrical conductive vias H (not illustrated in FIG. 1) is provided between the ground line 110A and the ground plate 110B. Note that a configuration in which a plurality of vias H is not provided is also possible.

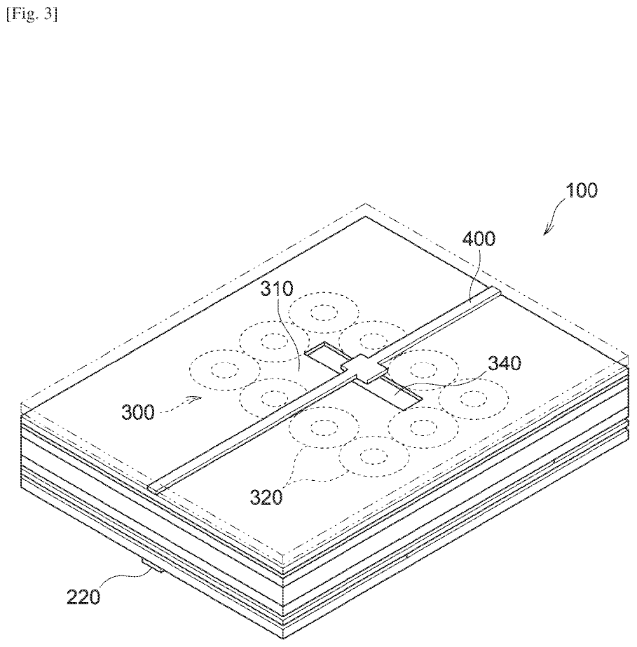

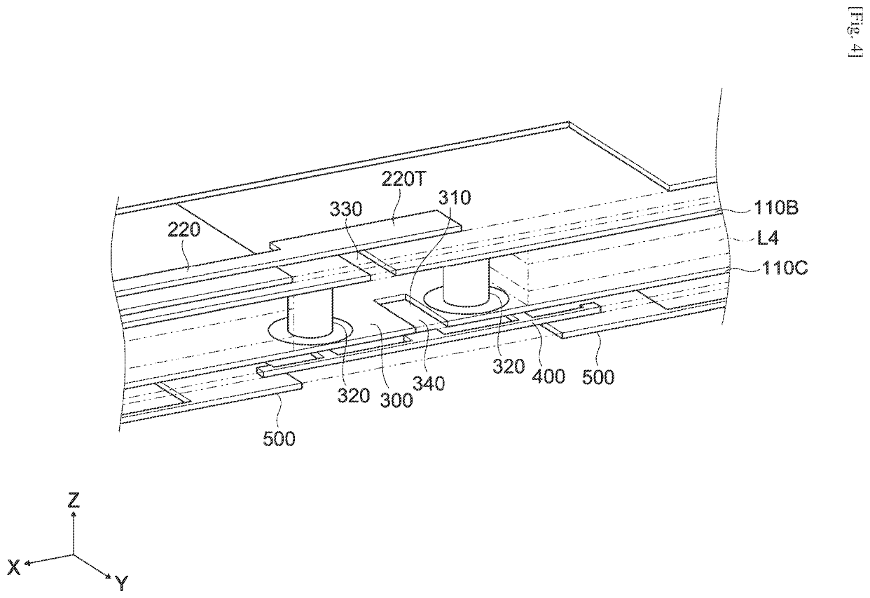

FIGS. 3 and 4 are diagrams for explaining the details of the waveguide 300. Specifically, FIG. 3 is a perspective view illustrating a part of the layers of the dielectric substrate 100 in a transparent manner. FIG. 4 is a perspective cross-sectional view illustrating a part of the dielectric substrate 100 from the back surface. In FIG. 4, the power supply line 200 is illustrated while a part of the power supply circuit side is omitted (a part of the signal line 220 is cut out).

The waveguide 300 propagates a millimeter-waveband signal (electromagnetic wave signal) fed from the power supply line 200 using the via 320 as a metal wall, and transmits (feeds) the propagated signal to the power feeding unit 400. The waveguide 300 includes a transmission unit (core) 310 that is a propagation space including an internal dielectric, and a plurality of vias 320 which surround a periphery of the transmission unit 310 and function as walls of the waveguide. The plated metal walls of the plurality of vias 320 serve as walls of the waveguide. Also, in the waveguide 300, a slot including a pair of ground plates 110B functions as an opening 330 through which an electromagnetic wave is input to the transmission unit 310. The slot including a pair of ground plates 110C functions as an opening 340 through which the signal propagating from the transmission unit 310 is supplied to the power feeding unit 400.

The end 220T of the power supply line 200 faces the opening 330 in a thickness direction of a substrate surface and couples the fed millimeter-waveband signal to the opening 330 of the waveguide 300 to input the signal to the waveguide 300. In the waveguide 300, the input millimeter wave signal propagates through the reflection by the metal wall of the via 320. The opening 340 on the output side faces the power feeding unit 400 and the waveguide 300 proximally couples the transmitted signal to the power feeding unit 400 via the opening 340 (outputs a signal from the waveguide).

In this manner, the waveguide 300 supplies the millimeter-waveband signal fed from the power supply line 200 to the power feeding unit 400.

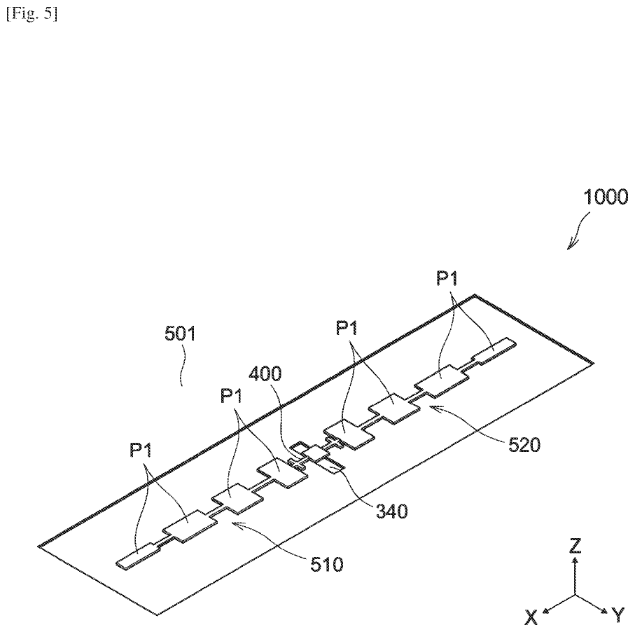

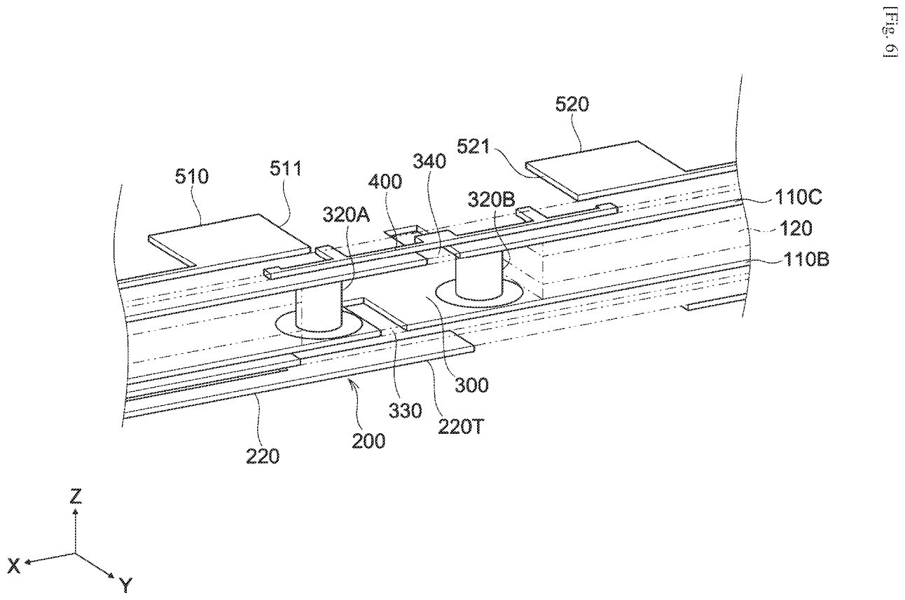

FIGS. 5 and 6 are diagrams for explaining the details of the antenna 500 and a peripheral structure thereof. FIG. 5 is an enlarged perspective view illustrating a surface of the L1 layer of the antenna device 1000. FIG. 6 is a partial cross-sectional view of the antenna device 1000 taken along a Y axis of FIG. 5.

The power feeding unit 400 receives the millimeter-waveband signal transmitted from the waveguide 300 and supplies the signal to the signal antenna 500 by proximity coupling. The antenna 500 includes an antenna element (first antenna element) 510 and an antenna element (second antenna element) 520. The element 510 corresponds to the first element of the antenna and the element 520 corresponds to the second element of the antenna.

The power feeding unit 400 is disposed between the layers L1 and L2 of the dielectric substrate 100. The power feeding unit 400 faces the opening 340 via the layer L2. Also, the power feeding unit 400 faces the ends 511 and 521 (refer to FIG. 6, such as first and second ends) of the elements 510 and 520 of the antenna 500 via the layer L1. With this configuration, the power feeding unit 400 supplies the millimeter-waveband signal received from the waveguide 300 to both elements of the antenna 500 from respective ends by proximity coupling. The power feeding unit 400 is disposed substantially at the center between the two elements 510 and 520 in a Y axis direction. More specifically, the power feeding unit 400 is provided between the end 511 and the end 521. The power feeding unit 400 is provided between a portion between the elements 510 and 520 and the opening 340 of the waveguide 300 in a thickness direction of the substrate, that is, in a direction perpendicular to the substrate surface (Z direction). In addition, the waveguide 300 is provided between a portion between the element 510 and the element 520 and the end 220T of the power supply line 200 in the thickness direction of the substrate.

The antenna 500 is an antenna which radiates radio waves. The antenna 500 includes the element 510 corresponding to the first element and the element 520 corresponding to the second element. As an example, the antenna 500 is formed by patterning a conductive foil on a surface of the dielectric substrate (layer L1). More specifically, the entire surface of the dielectric substrate (layer L1) is covered with the conductor foil 501 and the conductor foil in a region in which the antenna 500 is to be formed is patterned to form the antenna 500. Each of the elements 510 and 520 of the antenna 500 is configured by connecting a plurality of rectangular conductors P1 (patches) in a line in the same direction at regular intervals. Although the antenna is non-directional in the case of a single patch antenna, when a plurality of rectangular conductors P1 (patches) is arranged in a line, directivity (In the example of FIG. 5, for example, directivity in a Z direction) in a desired direction can be obtained by combining radiation patterns of the plurality of patches P1.

As an example, an interval between the patches P1 included in the elements 510 and 520 is substantially ½ of the used wavelength. The substantially ½ wavelength may include a ½ wavelength. When the directivity is directed in the Z axis front direction, the used wavelength may be set to ½ wavelength, and when the directivity is inclined from the Z axis front direction, the used wavelength may be set to approximately ½ wavelength (In this case, a value shifted from the ½ wavelength). The patches P1 are connected by a linear conductor. Also, the width (width in the Y axis direction) of each of the patches P1 may be any other width. At this time, in the case in which the width (width in the Y-axis direction) of the patch P1 increases, a radiation amount increases, and when the width is narrowed, the radiation amount decreases. Furthermore, in the example of FIG. 5, the antenna 500 narrows the width of the patch P1 toward a distal end to narrow the radiation amount and reduce a side lobe. Further. A length of the patch P1 in a length direction (X axis direction) is basically substantially ½ wavelength.

The end 511 (refer to FIG. 6) of the element 510 on the power feeding unit 400 side and the end 521 of the element 520 on the power feeding unit 400 side face each other and are separated from each other by a certain distance. The certain distance is substantially the same as that of the wavelength k of an operating frequency of the antenna 500. The center of the power feeding unit 400 in the Y axis direction and the center between the element 510 and the element 520 substantially coincide with each other in the Y axis direction. As a result, power is fed from the power feeding unit 400 to substantially the center of the antenna 500 (referred to as “central power feeding”). With the above configuration, signals having phases different from each other by approximately 180° are supplied from the power feeding unit 400 to the element 510 and the element 520. Note that, although the ends 511 and 521 face each other in the Y axis direction, it is also possible to adopt a configuration in which the ends 511 and 521 do not face each other in the Y axis direction or a configuration in which a part of each of the ends 511 and 521 faces each other by shifting the position of the ends 511 and 521 in the X axis direction.

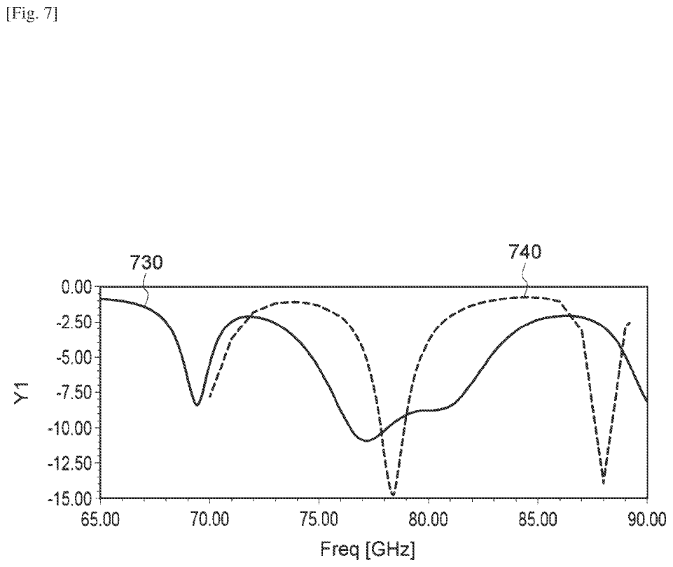

FIG. 7 illustrates an example in which a reflection intensity of a signal centrally fed to the antenna 500 by proximity coupling is measured in accordance with the embodiment. A graph 730 is a graph obtained by measurement of the antenna device 1000 according to the embodiment and a graph 740 is a graph obtained by measurement of the antenna device of the comparative example. The antenna device of the comparative example is an antenna device which directly performs power feeding (base power feeding) from only one end of the antenna.

As illustrated in FIG. 7, in the antenna device of the comparative example, a bandwidth (transmittable bandwidth) in which reflection from the antenna is within an allowable range is 1 GHz (substantially 1 GHz around a frequency ml). On the other hand, in the antenna device 1000, the bandwidth (transmittable bandwidth) in which the reflection from the antenna 500 is within the allowable range is 5 GHz (substantially 5 GHz from the frequency ml to a frequency m3). Therefore, in the embodiment, the band can be wider than that of the antenna device of the comparative example.

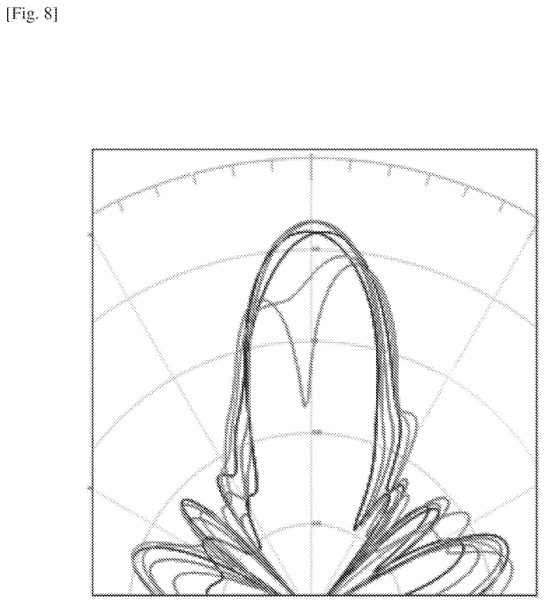

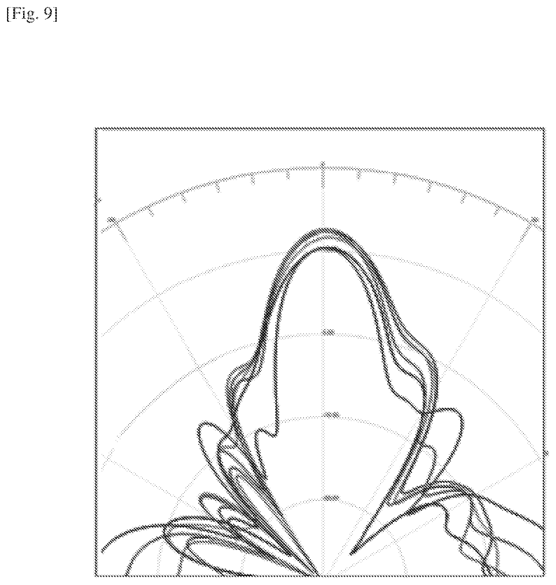

FIG. 8 illustrates a radiation pattern of the antenna device according to the comparative example. FIG. 9 illustrates a radiation pattern of the antenna device 1000 according to the present disclosure. As illustrated in FIG. 8, in the antenna device which performs base power feeding, when the frequency fluctuates, inclination or collapse of the radiation pattern (collapse of directivity) occurs.

On the other hand, as illustrated in FIG. 9, in the antenna device 1000 according to the present disclosure, at least one of the inclination of the radiation pattern and the collapse of the directivity is prevented regardless of the frequency variation.

Effects obtained by the embodiment will be described.
(1) According to the embodiment, it is possible to reduce the loss at the time of feeding power by performing back power supply. That is to say, in the case of the antenna device of the comparative example in which the power supply line is disposed on the same surface as the surface on which the antenna is disposed to feed power, it is necessary to route the power supply line from the power supply circuit to the power feeding point of the antenna while avoiding other components on the surface, and the loss increases. In addition, it is not realistic to route the wiring in the vicinity of the antenna in which the patches are disposed at half-wavelength intervals even in consideration of the influence on the antenna.

In the embodiment, the power supply line is disposed on the back surface of the substrate and power is fed from the power supply line to the antenna on the front side via a waveguide. Since the back surface has no or few components other than the power supply line, the transmission length is short. In addition, the loss of the waveguide is small. As a result, the loss from the power supply circuit to the power feeding point of the antenna can be reduced.
(2) According to the embodiment, the reflection loss can be reduced by feeding power using an in-substrate waveguide. In the embodiment, the power feeding using an in-substrate waveguide structure is a method of feeding power from the back surface of the substrate to the antenna 500 disposed on the surface of the substrate via the waveguide 300 provided inside the substrate.

With this structure, since a signal is transmitted by regarding the via as a metal wall of the waveguide, the via is not directly affected by manufacturing variations of the via and a characteristic impedance can be appropriately designed, in which the reflection loss is small.

More specifically, as a comparative example in which backside power feeding is performed by a method other than the in-substrate waveguide, there is a method using a via which directly transmits a signal between layers of the substrate. In this method, a signal is transmitted inside a via. This method is used in a case where a signal having a frequency lower than that of millimeter waves is used a target. However, in a signal having a high frequency such as millimeter waves, characteristic impedance collapses due to design conditions of a substrate, and reflection loss occurs. In addition, due to the conditions of board design, it is necessary to adopt a staggered method in which vias do not overlap at the same position between layers. The vias are directly susceptible to manufacturing variations of the vias themselves.

In the embodiment, since a waveguide using a via as a metal wall is used, it is difficult to be directly affected by manufacturing variations of the vias and characteristic impedance can be appropriately designed so that reflection loss can be reduced.
(3) According to the embodiment, power is fed to the central portion of the antenna 500 by proximity coupling so that the band can be widened. That is to say, as a method of feeding power to the antenna, in the comparative example, power is directly fed from the root of the antenna. In the root power feeding, the band is narrow and a radiation pattern is inclined in accordance with the fluctuation of the frequency. On the other hand, in the embodiment, power is fed from the center of the antenna by proximity coupling. As a result, the band can be widened and the inclination of the radiation pattern can be reduced in accordance with the fluctuation of the frequency.

### Modification 1

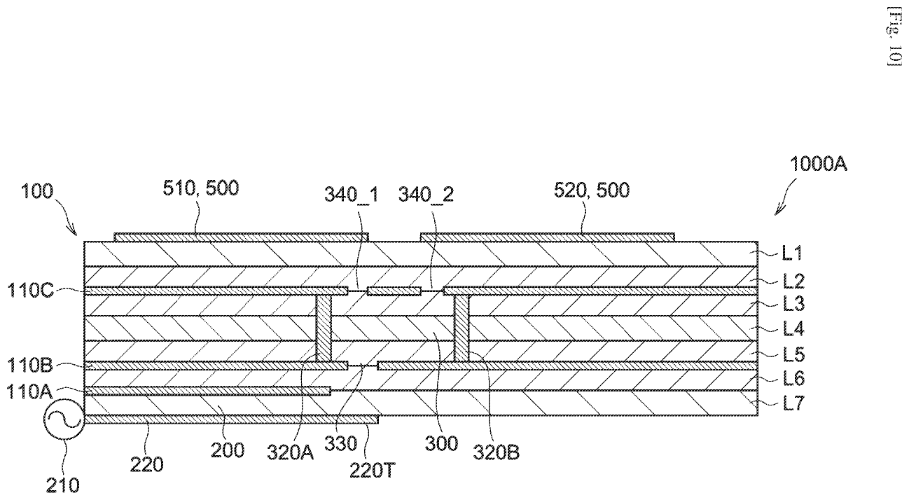

FIG. 10 is a block diagram illustrating a modification of the antenna device 1000. An antenna device 1000A does not include a power feeding unit 400. The antenna device 1000A directly feeds power to an antenna 500 by a plurality of slits 340_1 and 340_2 formed on an output side of a waveguide 300. The waveguide 300 includes an opening (slot) 340_1 through which power is fed to (proximity coupling is performed on) an element 510 and an opening (slot) 340_2 through which power is fed to an element 520. The opening 340_1 corresponds to a first opening as an example and the opening 340_2 corresponds to a second opening as an example. According to Modification 1, since the power feeding unit 400 is unnecessary, a configuration of the antenna device can be simplified.

### Modification 2

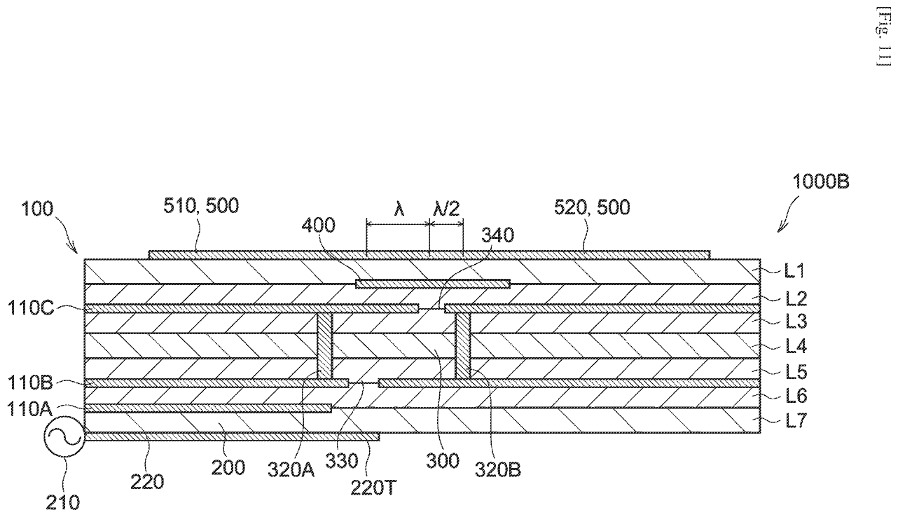

FIG. 11 is a block diagram illustrating a modification 1000B of the antenna device 1000. In an antenna 500, elements 510 and 520 are integrally connected. That is to say, an end of the element 510 and an end of the element 520 facing each other are connected. A distance from the connection portion to a first patch P1 (refer to FIG. 2) in the element 510 is a length of one wavelength (λ) of an operating frequency and a distance from the connection portion to the first patch P1 in the element 520 is a length of substantially ½ wavelength (λ/2) of the operating frequency. As a result, a length of the element 510 is longer than that of the element 520 by a wavelength of substantially ½ of the operating frequency. According to Modification 2, the number of elements can be reduced as compared with the case in which the antenna elements are separated.

### Modification 3

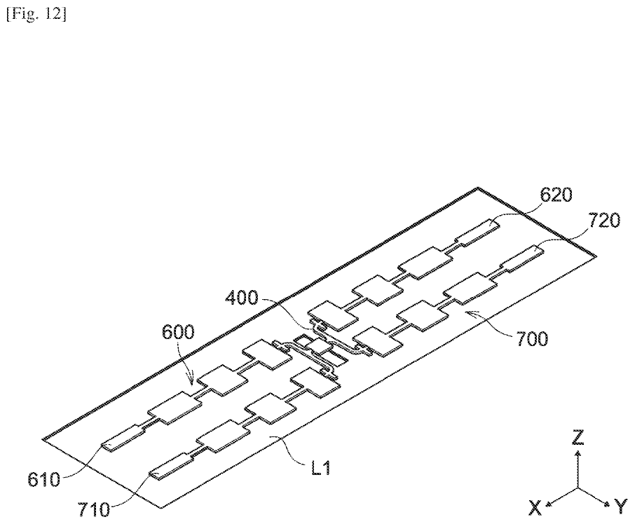

FIG. 12 is a diagram illustrating a modification of the antenna device 1000 according to the embodiment of the present disclosure. An antenna device of the modification includes two antennas 600 and 700. The two antennas 600 and 700 are substantially parallel to each other in a length direction and are disposed in a layer L1 at regular intervals in the X axis direction. The antenna 600 includes elements 610 and 620. The elements 610 and 620 face each other via a power feeding unit 400. The antenna 700 includes elements 710 and 720. The elements 710 and 720 face each other via the power feeding unit 400. The power feeding unit 400 simultaneously supplies a signal supplied from a waveguide to the antenna 600 and the antenna 700 by proximity coupling.

Although the number of antennas is 2 in the example of FIG. 12, the number of antennas may be 3 or more.

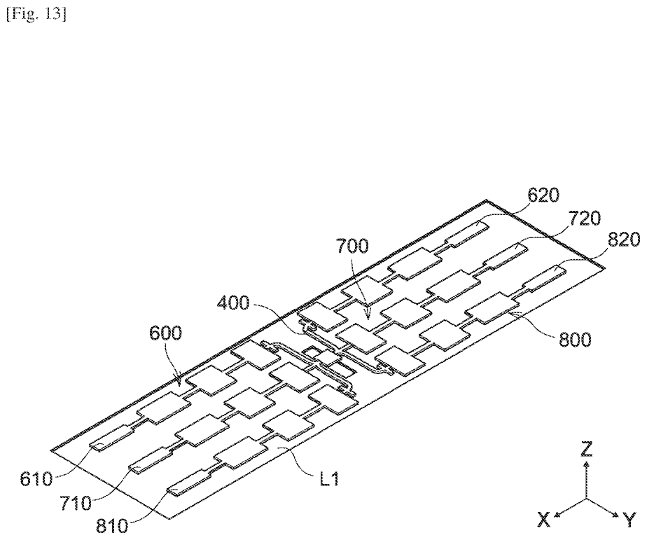

FIG. 13 is a diagram illustrating another modification of the antenna device 1000 according to the embodiment of the present disclosure. An antenna 800 is added to the antenna device of FIG. 12 and the number of antennas is 3. The antenna 800 includes elements 810 and 820. As described above, the number of antennas may be any number of two or more. Increasing the number of antennas facilitates adjustment of a radiation pattern.

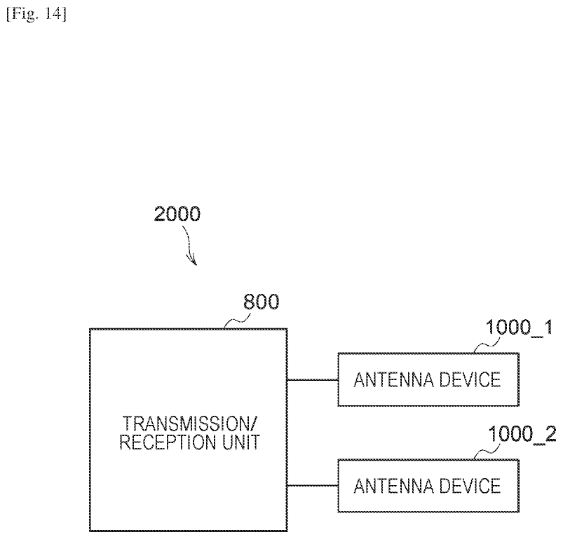

FIG. 14 is a block diagram of a radar device 2000 including the antenna device 1000 according to the embodiment of the present disclosure. The radar device 2000 is, for example, a millimeter wave radar device.

The radar device 2000 includes an antenna device 1000_1 for transmission, an antenna device 1000_2 for reception, and a transmission/reception unit 900. Although the antenna devices for transmission and reception are separately provided, one antenna device may be used for both transmission and reception. As an example, the radar device 2000 can be installed in a movable vehicle such as an automobile or a movable device. Here, the radar device 2000 may be provided in, for example, a fixedly installed device or system such as a fixedly installed monitoring device. The antenna device 1000_1 or the antenna device 1000_2 is an antenna device according to the above-described embodiment or any modification.

The transmission/reception unit 900 is a circuit which performs signal transmission processing and signal reception processing. The transmission/reception unit 900 generates a signal for transmission and supplies the signal from the power supply line of the antenna device 1000_1. In the antenna device 10001, the fed signal is transmitted to the power feeding unit via the waveguide and power is fed from the power feeding unit to the antenna 500 by proximity coupling. The antenna 500 radiates radio waves by resonance on the basis of a signal fed by proximity coupling. The antenna device 1000_2 receives reflected waves of the radiated radio waves and supplies the received signal to the transmission/reception unit 800. The transmission/reception unit 900 analyzes, for example, a state of a target from which the radio waves are reflected, a distance to the target, or the like on the basis of the reception signal.

### Application Example

An application example of the antenna device 1000 will be described below. The antenna device 1000 is also applicable to the following arbitrary in-vehicle control system, device, method, and the like.

### 1. Configuration Example of Vehicle Control System

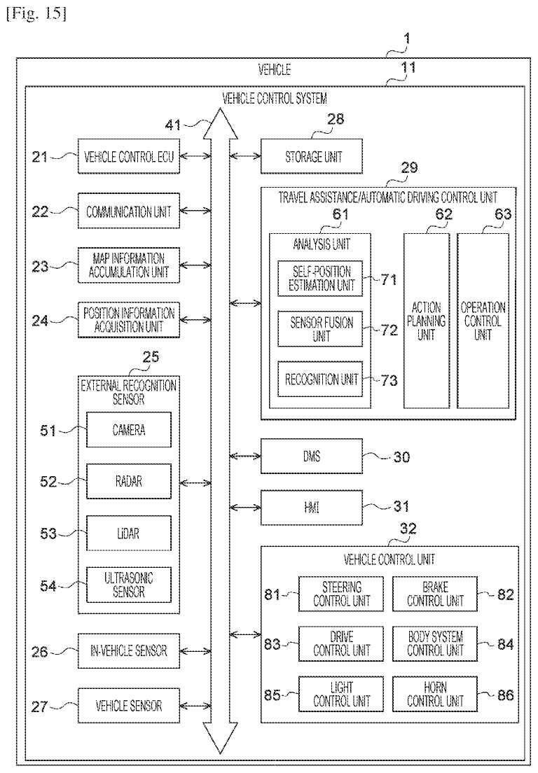

FIG. 15 is a block diagram illustrating a configuration example of a vehicle control system 11 that is an example of a mobile device control system to which present technology is applied. The antenna device according to the above-described embodiment or modification can be used as, for example, an antenna in the case in which the communication unit 22 performs wireless communication.

The vehicle control system 11 is provided in a vehicle 1 and performs processing relating to travel assistance and automated driving of the vehicle 1.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a travel assistance/automated driving control unit 29, a driver monitoring system (DMS) 30, a human machine interface (HMI) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance/automated driving control unit 29, the driver monitoring system (DMS) 30, the human machine interface (HMI) 31, and the vehicle control unit 32 are connected to each other in a communicable manner over a communication network 41. The communication network 41 includes, for example, an in-vehicle communication network conforming to a digital bidirectional communication standard such as a controller area network (CAN), a local interconnect network (LIN), a local area network (LAN). FlexRay (registered trademark), or Ethernet (registered trademark), a bus, or the like. The communication network 41 may be selectively used depending on a type of data to be transmitted. For example, the CAN may be applied to data relating to vehicle control and the Ethernet may be applied to large-capacity data. Note that each unit of the vehicle control system 11 may also be directly connected without going through the communication network 41 using, for example, wireless communication in which communication at a relatively short distance such as near field communication (NFC) or Bluetooth (registered trademark) is assumed in some cases.

Note that, in the case in which each unit of the vehicle control system 11 performs communication over the communication network 41, description of the communication network 41 will be omitted below. For example, in a case where the vehicle control ECU 21 and the communication unit 22 perform communication over the communication network 41, it is simply described that the vehicle control ECU 21 and the communication unit 22 perform communication.

The vehicle control ECU 21 includes, for example, various processors such as a central processing unit (CPU) and a micro processing unit (MPU). The vehicle control ECU 21 controls all or some of the functions of the vehicle control system 11.

The communication unit 22 communicates with various devices in and out of a vehicle, other vehicles, servers, base stations, and the like and transmits and receives various pieces of data. At this time, the communication unit 22 can perform communication using a plurality of communication methods.

Communication with the devices out of the vehicle executable by the communication unit 22 will be schematically described. The communication unit 22 communicates with a server (hereinafter, the server is referred to as an “external server”) or the like existing on an external network via a base station or an access point using, for example, a wireless communication method such as a 5th generation mobile communication system (5G), long term evolution (LTE), or dedicated short range communications (DSRCs). The external network with which the communication unit 22 communicates is, for example, the Internet, a cloud network, a network unique to a company, or the like. The communication method performed by the communication unit 22 on the external network is not particularly limited as long as it is a wireless communication method capable of performing digital bidirectional communication at a communication speed equal to or higher than a predetermined communication speed and at a distance equal to or longer than a predetermined distance.

Furthermore, for example, the communication unit 22 can communicate with a terminal existing in the vicinity of a host vehicle using a peer to peer (P2P) technology. The terminal existing in the vicinity of the host vehicle is, for example, a terminal installed in a moving body moving at a relatively low speed such as a pedestrian or a bicycle, a terminal installed in a store or the like with a position fixed, or a machine type communication (MTC) terminal. Furthermore, the communication unit 22 can also perform V2X communication. The V2X communication refers to, for example, communication between the host vehicle and another vehicle such as vehicle to vehicle communication with another vehicle, vehicle to infrastructure communication with a roadside device or the like, vehicle to home communication with house, and vehicle to pedestrian communication with a terminal or the like possessed by a pedestrian.

For example, the communication unit 22 can receive a program for updating software for controlling an operation of the vehicle control system 11 from the outside (Over The Air). The communication unit 22 can further receive map information, traffic information, information around the vehicle 1, and the like from the outside. Furthermore, for example, the communication unit 22 can transmit information regarding the vehicle 1, information around the vehicle 1, and the like to the outside. Examples of the information regarding the vehicle 1 transmitted to the outside by the communication unit 22 include, for example, data indicating a state of the vehicle 1, a recognition result by the recognition unit 73, and the like. Furthermore, for example, the communication unit 22 performs communication corresponding to a vehicle emergency call system such as an eCall.

For example, the communication unit 22 receives electromagnetic waves transmitted by a road traffic information communication system ((vehicle information and communication system (VICS)) (registered trademark)) such as a radio wave beacon, an optical beacon, or FM multiplex broadcasting.

Communication with the device in the vehicle executable by the communication unit 22 will be schematically described. The communication unit 22 can communicate with each device in the vehicle using, for example, wireless communication. The communication unit 22 can perform wireless communication with an in-vehicle device using, for example, a communication method capable of performing digital bidirectional communication at a predetermined communication speed or higher by wireless communication, such as wireless LAN, Bluetooth, NFC, or wireless USB (WUSB). The present disclosure is not limited thereto and the communication unit 22 can also communicate with each device in the vehicle using wired communication. For example, the communication unit 22 can communicate with each device in the vehicle by wired communication via a cable connected to a connection terminal (not illustrated). The communication unit 22 can communicate with each device in the vehicle using, for example, a communication method capable of performing digital bidirectional communication at a predetermined communication speed or higher by wired communication such as a universal serial bus (USB), a high-definition multimedia interface (HDMI) (registered trademark), or a mobile high-definition link (MHL).

Here, the in-vehicle device refers to, for example, a device which is not connected to the communication network 41 in the vehicle. As the in-vehicle device, for example, a mobile device or a wearable device possessed by a passenger such as a driver, an information device brought into the vehicle and temporarily installed, or the like is assumed.

The map information accumulation unit 23 accumulates one or both of a map acquired from the outside and a map created by the vehicle 1. For example, the map information accumulation unit 23 accumulates a three-dimensional high-precision map, a global map having accuracy lower than that of the highly accurate map and covering a wide area, and the like.

The high-precision map is, for example, a dynamic map, a point cloud map, a vector map, or the like. The dynamic map is, for example, a map including four layers that are dynamic information, semi-dynamic information, semi-static information, and static information and is provided from an external server or the like to the vehicle 1. The point cloud map is a map including point clouds (point cloud data). The vector map is, for example, a map in which traffic information such as a lane and a position of a traffic light and the like is associated with a point cloud map and adapted to an advanced driver assistance system (ADAS) or automated driving (AD).

The point cloud map and the vector map may be provided from, for example, an external server or the like, or may be created by the vehicle 1 as a map for performing matching with a local map which will be described later on the basis of a sensing result by the camera 51, the radar 52 (such as a radar device in the claims), the LiDAR 53, or the like, and may be accumulated in the map information accumulation unit 23. In addition, in the case in which a high-precision map is provided from an external server or the like, for example, map data of several hundred meters square regarding a planned path on which the vehicle 1 travels from now is acquired from an external server or the like in order to reduce the communication capacity.

The position information acquisition unit 24 receives a global navigation satellite system (GNSS) signal from a GNSS satellite and acquires position information of the vehicle 1. The acquired position information is supplied to the travel assistance/automated driving control unit 29. Note that the signal acquisition method of the position information acquisition unit 24 is not limited to the method using the GNSS signal and may acquire the position information using, for example, a beacon.

The external recognition sensor 25 includes various sensors used for recognizing a situation outside the vehicle 1, and supplies sensor data from each sensor to each unit of the vehicle control system 11. The type and number of sensors included in the external recognition sensor 25 are arbitrary.

For example, the external recognition sensor 25 includes the camera 51, the radar 52, the light detection and ranging or laser imaging detection and ranging (LiDAR) 53, and the ultrasonic sensor 54. The present disclosure is not limited thereto and the external recognition sensor 25 may be a configuration that includes one or more types of sensors among the camera 51, the radar 52, the LiDAR 53, and the ultrasonic sensor 54. The numbers of the cameras 51, the radars 52, the LiDAR 53, and the ultrasonic sensors 54 are not particularly limited as long as they can be practically installed in the vehicle 1. Furthermore, the type of sensor included in the external recognition sensor 25 is not limited to this example and the external recognition sensor 25 may include another type of sensor. An example of the sensing region of each sensor included in the external recognition sensor 25 will be described later.

Note that an imaging method of the camera 51 is not particularly limited. For example, cameras of various imaging methods such as a time-of-flight (ToF) camera, a stereo camera, a monocular camera, and an infrared camera that are imaging methods capable of performing distance measurement can be applied to the camera 51 as necessary. The present disclosure is not limited thereto and the camera 51 may simply acquire a captured image regardless of distance measurement.

Furthermore, for example, the external recognition sensor 25 can include an environment sensor for detecting the environment for the vehicle 1. The environment sensor is a sensor for detecting an environment such as climate, weather, and brightness and can include, for example, various sensors such as a raindrop sensor, a fog sensor, a sunshine sensor, a snow sensor, and an illuminance sensor.

Furthermore, for example, the external recognition sensor 25 includes a microphone used for detecting a sound around the vehicle 1, a position of a sound source, and the like.

The in-vehicle sensor 26 includes various sensors for detecting information in the vehicle and supplies sensor data from each sensor to each unit of the vehicle control system 11. The type and number of various sensors included in the in-vehicle sensor 26 are not particularly limited as long as they are types and numbers which can be practically installed in the vehicle 1.

For example, the in-vehicle sensor 26 can include one or more sensors of a camera, a radar, a seating sensor, a steering wheel sensor, a microphone, and a biological sensor. As the camera included in the in-vehicle sensor 26, for example, cameras of various imaging methods capable of measuring a distance such as a ToF camera, a stereo camera, a monocular camera, and an infrared camera can be used.

The present disclosure is not limited thereto and the camera included in the in-vehicle sensor 26 may simply acquire a captured image regardless of distance measurement. The biological sensor included in the in-vehicle sensor 26 is provided, for example, on a seat, a steering wheel, or the like and detects various types of biological information regarding an occupant such as a driver.

The vehicle sensor 27 includes various sensors for detecting a state of the vehicle 1 and supplies sensor data from each sensor to each unit of the vehicle control system 11. The type and number of various sensors included in the vehicle sensor 27 are not particularly limited as long as they are types and numbers which can be practically installed in the vehicle 1.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor which detects a steering angle of a steering wheel, a yaw rate sensor, an accelerator sensor which detects an operation amount of an accelerator pedal, and a brake sensor which detects an operation amount of a brake pedal. For example, the vehicle sensor 27 includes a rotation sensor which detects a rotation speed of an engine or the motor, an air pressure sensor which detects an air pressure of a tire, a slip rate sensor which detects a slip rate of a tire, and a wheel speed sensor which detects a rotation speed of a wheel. For example, the vehicle sensor 27 includes a battery sensor which detects a remaining amount and a temperature of a battery and an impact sensor which detects an external impact.

The storage unit 28 includes at least one of a nonvolatile storage medium or a volatile storage medium, and stores data and a program. The storage unit 28 is used as, for example, an electrically erasable programmable read-only memory (EEPROM) and a random access memory (RAM) and a magnetic storage device such as a hard disc drive (HDD), a semiconductor storage device, an optical storage device, and a magneto-optical storage device can be applied as the storage medium. The storage unit 28 stores various programs and data used by each unit of the vehicle control system 11. For example, the storage unit 28 includes an event data recorder (EDR) and a data storage system for automated driving (DSSAD) and stores information regarding the vehicle 1 before and after an event such as an accident and information acquired by the in-vehicle sensor 26.

The travel assistance/automated driving control unit 29 controls travel support and automated driving of the vehicle 1. For example, the travel assistance/automated driving control unit 29 includes an analysis unit 61, an action planning unit 62, and an operation control unit 63.

The analysis unit 61 performs analysis processing of a situation of the vehicle 1 and the surroundings. The analysis unit 61 includes a self-position estimation unit 71, a sensor fusion unit 72, and a recognition unit 73.

The self-position estimation unit 71 estimates a position of the host vehicle 1 itself on the basis of the sensor data from the external recognition sensor 25 and the high-precision map accumulated in the map information accumulation unit 23. For example, the self-position estimation unit 71 generates a local map on the basis of sensor data from the external recognition sensor 25 and estimates the position of the host vehicle 1 itself by matching the local map with the high-precision map. The position of the vehicle 1 is based on, for example, the center of the rear wheel-to-axle.

The local map is, for example, a three-dimensional high-precision map created using a technique such as simultaneous localization and mapping (SLAM), an occupancy grid map, or the like. The three-dimensional high-precision map is, for example, the above-described point cloud map or the like. The occupancy grid map is a map in which a three-dimensional or two-dimensional space around the vehicle 1 is divided into grids (lattices) of a predetermined size and an occupancy state of an object is indicated in units of grids. The occupancy state of the object is indicated by, for example, the presence or absence or existence probability of the object. The local map is also used for, for example, detection processing and recognition processing of a situation outside the vehicle 1 by the recognition unit 73.

Note that the self-position estimation unit 71 may estimate the position of the host vehicle 1 itself on the basis of the position information acquired by the position information acquisition unit 24 and the sensor data from the vehicle sensor 27.

The sensor fusion unit 72 performs sensor fusion processing of combining a plurality of different types of pieces of sensor data (for example, image data supplied from the camera 51 and sensor data supplied from the radar 52.) to obtain new information. Methods of combining different types of pieces of sensor data include integration, fusion, association, and the like.

The recognition unit 73 performs detection processing of detecting a situation outside the vehicle 1 and recognition processing of recognizing a situation outside the vehicle 1.

For example, the recognition unit 73 performs detection processing and recognition processing of a situation outside the vehicle 1 on the basis of information from the external recognition sensor 25, information from the self-position estimation unit 71, information from the sensor fusion unit 72, and the like.

Specifically, for example, the recognition unit 73 performs detection processing, recognition processing, and the like of an object around the vehicle 1. The object detection processing is, for example, processing of detecting the presence or absence, size, shape, position, motion, and the like of an object. The object recognition processing is, for example, processing of recognizing an attribute such as a type of an object or identifying a specific object. Here, the detection processing and the recognition processing are not necessarily clearly divided and may overlap.

For example, the recognition unit 73 detects an object around the vehicle 1 by performing clustering to classify point clouds based on sensor data by the radar 52, the LiDAR 53, or the like into clusters of point clouds. As a result, the presence or absence, size, shape, and position of an object around the vehicle 1 are detected.

For example, the recognition unit 73 detects the motion of the object around the vehicle 1 by performing tracking which follows the motion of the mass of the point cloud classified by clustering. As a result, a speed and a traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and the like on the basis of the image data supplied from the camera 51. Furthermore, the recognition unit 73 may recognize the type of the object around the vehicle 1 by performing recognition processing such as semantic segmentation.

For example, the recognition unit 73 can perform recognition processing of traffic rules around the vehicle 1 on the basis of a map accumulated in the map information accumulation unit 23, an estimation result of the self-position by the self-position estimation unit 71, and a recognition result of an object around the vehicle 1 by the recognition unit 73. Through this process, the recognition unit 73 can recognize a position and a state of a traffic light, the contents of a traffic sign and a road marking, the contents of a traffic regulation, a travelable lane, and the like.

For example, the recognition unit 73 can perform recognition processing of the environment around the vehicle 1. As the surrounding environment to be recognized by the recognition unit 73, climate, temperature, humidity, brightness, a state of a road surface, and the like are assumed.

The action planning unit 62 creates an action plan of the vehicle 1. For example, the action planning unit 62 creates an action plan by performing processing of path planning and path following.

Note that the global path planning is a process of planning a rough path from the start to the goal. This path planning includes processing called a trajectory planning of performing trajectory generation (a local path planning) which enables safe and smooth traveling in the vicinity of the vehicle 1 in consideration of the motion characteristics of the vehicle 1 in the planned path.

The path following is a process of planning an operation for safely and accurately traveling a path planned by a path planning within a planned time. For example, the action planning unit 62 can calculate a target speed and a target angular velocity of the vehicle 1 on the basis of the result of the path following processing.

The operation control unit 63 controls an operation of the vehicle 1 in order to realize an action plan created by the action planning unit 62.

For example, the operation control unit 63 controls the steering control unit 81, the brake control unit 82, and the drive control unit 83 included in the vehicle control unit 32 which will be described later and performs acceleration/deceleration control and direction control such that the vehicle 1 travels on the trajectory calculated by the trajectory plan. For example, the operation control unit 63 performs cooperative control for the purpose of implementing the functions of the ADAS such as collision avoidance or impact mitigation, follow-up traveling, vehicle speed maintaining traveling, collision warning of the host vehicle, and lane deviation warning of the host vehicle. For example, the operation control unit 63 performs cooperative control for the purpose of automated driving in which the vehicle automatedly travels regardless of a driver's operation or the like.

The DMS 30 performs an authentication process of the driver, a recognition process of the state of the driver, and the like on the basis of sensor data from the in-vehicle sensor 26, input data input to the HMI 31 which will be described later, and the like. As the state of the driver to be recognized, for example, a physical condition, a wakefulness level, a concentration level, a fatigue level, a line-of-sight direction, a drunkenness level, a driving operation, a posture, and the like are assumed.

Note that the DMS 30 may perform authentication processing of a passenger other than the driver and recognition processing of a state of the passenger. Furthermore, for example, the DMS 30 may perform recognition processing of the situation in the vehicle on the basis of sensor data from the in-vehicle sensor 26. As the situation in the vehicle to be recognized, for example, temperature, humidity, brightness, odor, and the like are assumed.

The HMI 31 inputs various pieces of data, instructions, and the like, and presents various pieces of data to the driver or the like.

Data input by the HMI 31 will be schematically described. The HMI 31 includes an input device for a person to input data. The HMI 31 generates an input signal on the basis of data, an instruction, or the like input by an input device and supplies the input signal to each unit of the vehicle control system 11. The HMI 31 includes, for example, an operator such as a touch panel, a button, a switch, and a lever as an input device. The present disclosure is not limited thereto and the HMI 31 may further include an input device capable of inputting information by a method other than a manual operation using voice, gesture, or the like. Furthermore, the HMI 31 may use, for example, a remote control device using infrared rays or radio waves or an external connection device such as a mobile device or a wearable device according to an operation of the vehicle control system 11 as an input device.

Presentation of data by the HMI 31 will be schematically described. The HMI 31 generates visual information, auditory information, and tactile information regarding a passenger or the outside of the vehicle. In addition, the HMI 31 performs output control for controlling an output, an output content, an output timing, an output method, and the like of each piece of generated information. The HMI 31 generates and outputs, for example, an operation screen, state display of the vehicle 1, warning display, an image such as a monitor image indicating a situation around the vehicle 1, and information indicated by light, as the visual information. Furthermore, the HMI 31 generates and outputs, for example, information indicated by sounds such as a voice guidance, a warning sound, and a warning message, as the auditory information. Furthermore, the HMI 31 generates and outputs, for example, information given to the tactile sense of a passenger by, a force, a vibration, a motion, or the like, as the tactile information.

As an output device from which the HMI 31 outputs visual information, for example, a display device which presents visual information by displaying an image by the display device itself or a projector device which presents visual information by projecting an image can be applied. Note that the display device may be, for example, a device which displays visual information in the field of view of a passenger such as a head-up display, a transmissive type display, or a wearable device having an augmented reality (AR) function, in addition to a display device having a normal display. Furthermore, in the HMI 31, a display device included in a navigation device, an instrument panel, a camera monitoring system (CMS), an electronic mirror, a lamp, or the like provided in the vehicle 1 can also be used as an output device which outputs visual information.

As an output device from which the HMI 31 outputs the auditory information, for example, an audio speaker, a headphone, or an earphone can be applied.

As an output device from which the HMI 31 outputs tactile information, for example, a haptic element using a haptic technique can be applied. The haptics element is provided, for example, at a portion with which a passenger of the vehicle 1 comes into contact such as a steering wheel or a seat.

The vehicle control unit 32 controls each unit of the vehicle 1. The vehicle control unit 32 includes the steering control unit 81, the brake control unit 82, the drive control unit 83, the body system control unit 84, the light control unit 85, and the horn control unit 86.

The steering control unit 81 performs detection, control, and the like of a state of the steering system of the vehicle 1. The steering system includes, for example, a steering mechanism including a steering wheel and the like, an electric power steering, and the like. The steering control unit 81 includes, for example, a steering ECU which controls a steering system, an actuator which drives the steering system, and the like.

The brake control unit 82 performs detection, control, and the like of a state of the brake system of the vehicle 1. The brake system includes, for example, a brake mechanism including a brake pedal, an antilock brake system (ABS), a regenerative brake mechanism, and the like. The brake control unit 82 includes, for example, a brake ECU which controls the brake system, an actuator which drives the brake system, and the like.

The drive control unit 83 performs detection, control, and the like of a state of the drive system of the vehicle 1. The drive system includes, for example, an accelerator pedal, a driving force generator for generating a driving force of an internal combustion engine or a driving motor or the like, a driving force transmission mechanism for transmitting a driving force to wheels, and the like. The drive control unit 83 includes, for example, a drive ECU which controls the drive system, an actuator which drives the drive system, and the like.

The body system control unit 84 performs detection, control, and the like of a state of a body system of the vehicle 1. The body system includes, for example, a keyless entry system, a smart key system, a power window device, a power seat, an air conditioner, an airbag, a seat belt, a shift lever, and the like. The body system control unit 84 includes, for example, a body system ECU which controls the body system, an actuator which drives the body system, and the like.

The light control unit 85 performs detection, control, and the like of states of various lights of the vehicle 1. As the light to be controlled, for example, a headlight, a backlight, a fog light, a turn signal, a brake light, a projection, a display of a bumper, and the like are assumed. The light control unit 85 includes a light ECU which controls light, an actuator which drives light, and the like.

The horn control unit 86 performs detection, control, and the like of a state of a car horn of the vehicle 1. The horn control unit 86 includes, for example, a horn ECU which controls a car horn, an actuator which drives the car horn, and the like.

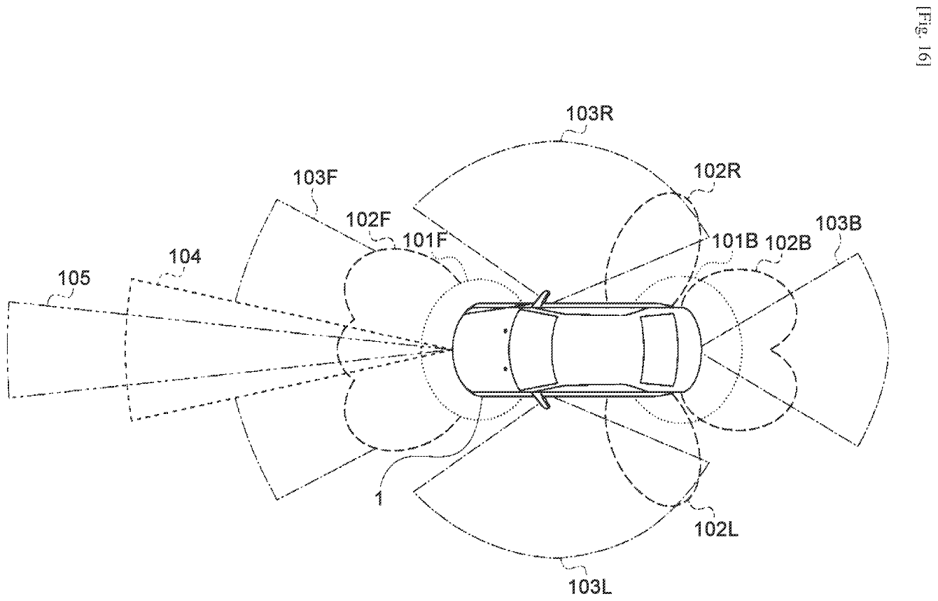

FIG. 16 is a diagram illustrating an example of a sensing region using the camera 51, the radar 52, the LiDAR 53, the ultrasonic sensor 54, and the like of the external recognition sensor 25 in FIG. 15. Note that FIG. 16 schematically illustrates the vehicle 1 when viewed from above in which a left end side is a front end (front) side of the vehicle 1 and a right end side is a rear end (rear) side of the vehicle 1.

A sensing region 101F and a sensing region 101B illustrate examples of the sensing region of the ultrasonic sensor 54. The sensing region 101F covers the periphery of the front end of the vehicle 1 using the plurality of ultrasonic sensors 54. The sensing region 101B covers the periphery of the rear end of the vehicle 1 using the plurality of ultrasonic sensors 54.

The sensing results in the sensing region 101F and the sensing region 101B are used, for example, for parking assistance of the vehicle 1.

Sensing regions 102F to 102B illustrate examples of sensing regions of the radar 52 for a short distance or a middle distance. The sensing region 102F covers a position farther than the sensing region 101F in front of the vehicle 1. The sensing region 102B covers a position farther than the sensing region 101B behind the vehicle 1. The sensing region 102L covers the rear periphery of the left side surface of the vehicle 1. The sensing region 102R covers the rear periphery of the right side surface of the vehicle 1.

The sensing result in the sensing region 102F is used, for example, for detecting a vehicle, a pedestrian, or the like existing in front of the vehicle 1. The sensing result in the sensing region 102B is used, for example, for a collision prevention function behind the vehicle 1. The sensing results in the sensing region 102L and the sensing region 102R are used, for example, for detecting an object in a blind spot on the side of the vehicle 1.

Sensing regions 103F to 103B illustrate examples of sensing regions using the camera 51. The sensing region 103F covers a position farther than the sensing region 102F in front of the vehicle 1. The sensing region 103B covers a position farther than the sensing region 102B behind the vehicle 1. The sensing region 103L covers the periphery of the left side surface of the vehicle 1. The sensing region 103R covers the periphery of the right side surface of the vehicle 1.

The sensing result in the sensing region 103F can be used for, for example, recognition of a traffic light or a traffic sign, a lane departure prevention assist system, and an automatic headlight control system. The sensing result in the sensing region 103B can be used for, for example, parking assistance and a surround view system. The sensing results in the sensing region 103L and the sensing region 103R can be used, for example, for a surround view system.

A sensing region 104 illustrates an example of a sensing region of the LiDAR 53. The sensing region 104 covers a position farther than the sensing region 103F in front of the vehicle 1. On the other hand, the sensing region 104 has a narrower range in a leftward/rightward direction than the sensing region 103F.

The sensing result in the sensing region 104 is used, for example, for detecting an object such as a surrounding vehicle.

The sensing region 105 illustrates an example of a sensing region of the long-range radar 52. The sensing region 105 covers a position farther than the sensing region 104 in front of the vehicle 1. On the other hand, the sensing region 105 has a narrower range in the leftward/rightward direction than the sensing region 104.

The sensing results in the sensing region 105 are used for, for example, adaptive cruise control (ACC), emergency braking, collision avoidance, and the like.

Note that the sensing regions of the sensors of the camera 51, the radar 52, the LiDAR 53, and the ultrasonic sensor 54 included in the external recognition sensor 25 may have various configurations other than those in FIG. 16. Specifically, the ultrasonic sensor 54 may also sense the side of the vehicle 1 or the LiDAR 53 may sense the rear of the vehicle 1. In addition, an installation position of each sensor is not limited to each example described above. Furthermore, the number of sensors may be one or more.

Note that the present disclosure is not limited to the above-described embodiment as it is and the constituent elements can be modified and embodied without departing from the gist of the present disclosure in the implementation stage. In addition, various matters can be formed by appropriately combining a plurality of constituent elements disclosed in the above embodiments. For example, some constituent elements may be omitted from all of the constituent elements illustrated in the embodiments. Furthermore, the constituent elements of different embodiments may be appropriately combined.

Furthermore, the effects of the present disclosure described in this specification are merely examples and other effects may be provided.

Note that the present disclosure can also have the following configurations:

### Item 1

An antenna device comprising:
a dielectric substrate;
a power supply line disposed on a first surface of the dielectric substrate;
a waveguide configured to transmit a signal fed from the power supply line in the dielectric substrate;
a first antenna element disposed on a second surface of the dielectric substrate and configured to receive the signal supplied from the waveguide by a first proximity coupling; and
a second antenna element disposed on the second surface of the dielectric substrate and configured to receive the signal supplied from the waveguide by a second proximity coupling.

### Item 2

The antenna device according to item 1, wherein
the first antenna element includes a first end,
the second antenna element includes a second end, and
the first end faces the second end with a space between the first end and the second end.

### Item 3

The antenna device according to item 2, wherein
the waveguide is provided between an end of the power supply line and a portion between the first end of the first antenna element and the second end of the second antenna element in a thickness direction of the dielectric substrate.

### Item 4

The antenna device according to item 2 or item 3, comprising:
a power feeding unit configured to receive the signal supplied from the waveguide and supply the signal to the first end of the first antenna element by the first proximity coupling and to the second end of the second antenna element by the second proximity coupling.

### Item 5

The antenna device according to item 4, wherein
the power feeding unit is provided between an end of the waveguide on an antenna side and a portion between the first antenna element and the second antenna element in a thickness direction of the dielectric substrate.

### Item 6

The antenna device according to item 5, wherein
the power feeding unit is configured to supply the signal received from the end of the waveguide on the antenna side to the first end of the first antenna element by the first proximity coupling and to the second end of the second antenna element by the second proximity coupling.

### Item 7

The antenna device according to any one of items 2 to 6, wherein
a length of the first antenna element is substantially the same as a length of the second antenna element.

### Item 8

The antenna device according to any one of items 2 to 7, wherein
an end of the waveguide on an antenna side has a first aperture and a second aperture,
the signal transmitted through the waveguide is supplied to the first end of the first antenna element through the first aperture, and
the signal transmitted through the waveguide is supplied to the second end of the second antenna element through the second aperture.

### Item 9

The antenna device according to item 8, wherein
the signal is supplied to the first end of the first antenna element through the first aperture by the first proximity coupling, and
the signal is supplied to the second end of the second antenna element through the second aperture by the second proximity coupling.

### Item 10

The antenna device according to any one of items 1 to 9, wherein
the first antenna element and the second antenna element are connected together forming an integral antenna structure.

### Item 11

The antenna device according to item 10, wherein
a length of one of the first antenna element or the second antenna element is longer than a length of the other one of the first antenna element or the second antenna element by substantially a half of a wavelength,
the wavelength is defined by a frequency of the signal.

### Item 12

The antenna device according to any one of items 1 to 11, further comprising:
a plurality of antenna elements including the first antenna element and the second antenna element.

### Item 13

The antenna device according to any one of items 2 to 9, wherein
a length of the space is substantially one wavelength defined by a frequency of the signal.

### Item 14

The antenna device according to any one of items 1 to 13, wherein
the first antenna element and the second antenna element each comprises a plurality of patch elements.

### Item 15

The antenna device according to item 4, wherein
a center of the power feeding unit is between the first end of the first antenna element and the second end of the second antenna element in a longitudinal direction of the dielectric substrate.

### Item 16

The antenna device according to item 4, wherein
the power feeding unit comprises a plate-shaped conductive member.

### Item 17

The antenna device according to any one of items 1 to 16, wherein
the waveguide is formed by a plurality of vias and a plurality of ground plates.

### Item 18

The antenna device according to any one of items 1 to 17, wherein
the antenna device is mounted on a vehicle.

### Item 19

A radar device comprising:
an antenna device including
a dielectric substrate,
a power supply line disposed on a first surface of the dielectric substrate,
a waveguide which transmits a signal fed from the power supply line in the dielectric substrate,
a first antenna disposed on a second surface of the dielectric substrate and configured to receive the signal supplied from the waveguide by a first proximity coupling, and
a second antenna element disposed on the second surface of the dielectric substrate and configured to receive the signal supplied from the waveguide by a second proximity coupling; and
a transmission/reception unit configured to:
transmit a transmission signal with the antenna device, and
receive a reception signal with the antenna device.

### Item 20

A vehicle control system comprising:
a radar device mounted on a vehicle, the radar device including
an antenna device including
a dielectric substrate,
a power supply line disposed on a first surface of the dielectric substrate,
a waveguide which transmits a signal fed from the power supply line in the dielectric substrate,
a first antenna disposed on a second surface of the dielectric substrate and configured to receive the signal supplied from the waveguide by a first proximity coupling, and
a second antenna element disposed on the second surface of the dielectric substrate and configured to receive the signal supplied from the waveguide by a second proximity coupling; and
a transmission/reception unit configured to:
transmit a transmission signal with the antenna device, and
receive a reception signal with the antenna device; and
a vehicle control unit configured to control an operation of the vehicle based on a sensing result of the radar device.

### REFERENCE SIGNS LIST

1000 Antenna device
2000 Radar device
100 Dielectric substrate
110A, 110B, 110C Ground plate
200 Power supply line
210 Power supply circuit
220 Signal line
220T End
300 Waveguide
310 Transmission unit
320A, 320B Via
330, 340, 340_1, 340_2 Opening (slot)
400 Power feeding unit
500, 600, 700, 800 Antenna
510, 520, 610, 620, 710, 720, 810, 820 Element
511, 521 End
730, 740 Graph
900 Transmission/reception unit
1 Vehicle
11 Vehicle system
21 Vehicle control electronic control unit (ECU)
22 Communication unit
23 Map information accumulation unit
24 Position information acquisition unit
25 External recognition sensor
26 In-vehicle sensor
27 Vehicle sensor
28 Storage unit
29 Travel assistance/automated driving control unit
30 Driver monitoring system (DMS)
31 Human machine interface (HMI)
32 Vehicle control unit
41 Communication network
51 Camera
52 Radar
53 LiDAR
54 Ultrasonic sensor
61 Analysis unit
62 Action planning unit
63 Operation control unit
71 Self-position estimation unit
72 Sensor fusion unit
73 Recognition unit
81 Steering control unit
82 Brake control unit
83 Drive control unit
84 Body system control unit
85 Light control unit
86 Horn control unit

1. An antenna device comprising:
a dielectric substrate;
a power supply line disposed on a first surface of the dielectric substrate;
a waveguide configured to transmit a signal fed from the power supply line in the dielectric substrate;
a first antenna element disposed on a second surface of the dielectric substrate and configured to receive the signal supplied from the waveguide by a first proximity coupling; and
a second antenna element disposed on the second surface of the dielectric substrate and configured to receive the signal supplied from the waveguide by a second proximity coupling.

2. The antenna device according to claim 1, wherein
the first antenna element includes a first end,
the second antenna element includes a second end, and
the first end faces the second end with a space between the first end and the second end.

3. The antenna device according to claim 2, wherein
the waveguide is provided between an end of the power supply line and a portion between the first end of the first antenna element and the second end of the second antenna element in a thickness direction of the dielectric substrate.

4. The antenna device according to claim 2, comprising:
a power feeding unit configured to receive the signal supplied from the waveguide and supply the signal to the first end of the first antenna element by the first proximity coupling and to the second end of the second antenna element by the second proximity coupling.

5. The antenna device according to claim 4, wherein
the power feeding unit is provided between an end of the waveguide on an antenna side and a portion between the first antenna element and the second antenna element in a thickness direction of the dielectric substrate.

6. The antenna device according to claim 5, wherein
the power feeding unit is configured to supply the signal received from the end of the waveguide on the antenna side to the first end of the first antenna element by the first proximity coupling and to the second end of the second antenna element by the second proximity coupling.

7. The antenna device according to claim 2, wherein
a length of the first antenna element is substantially the same as a length of the second antenna element.

8. The antenna device according to claim 2, wherein
an end of the waveguide on an antenna side has a first aperture and a second aperture,
the signal transmitted through the waveguide is supplied to the first end of the first antenna element through the first aperture, and
the signal transmitted through the waveguide is supplied to the second end of the second antenna element through the second aperture.

9. The antenna device according to claim 8, wherein
the signal is supplied to the first end of the first antenna element through the first aperture by the first proximity coupling, and
the signal is supplied to the second end of the second antenna element through the second aperture by the second proximity coupling.

10. The antenna device according to claim 1, wherein
the first antenna element and the second antenna element are connected together forming an integral antenna structure.

11. The antenna device according to claim 10, wherein
a length of one of the first antenna element or the second antenna element is longer than a length of the other one of the first antenna element or the second antenna element by substantially a half of a wavelength,
the wavelength is defined by a frequency of the signal.

12. The antenna device according to claim 1, further comprising:
a plurality of antenna elements including the first antenna element and the second antenna element.

13. The antenna device according to claim 2, wherein
a length of the space is substantially one wavelength defined by a frequency of the signal.

14. The antenna device according to claim 1, wherein
the first antenna element and the second antenna element each comprises a plurality of patch elements.

15. The antenna device according to claim 4, wherein
a center of the power feeding unit is between the first end of the first antenna element and the second end of the second antenna element in a longitudinal direction of the dielectric substrate.

16. The antenna device according to claim 4, wherein
the power feeding unit comprises a plate-shaped conductive member.

17. The antenna device according to claim 1, wherein
the waveguide is formed by a plurality of vias and a plurality of ground plates.

18. The antenna device according to claim 1, wherein
the antenna device is mounted on a vehicle.

19. A radar device comprising:
an antenna device including
a dielectric substrate,
a power supply line disposed on a first surface of the dielectric substrate,
a waveguide which transmits a signal fed from the power supply line in the dielectric substrate,
a first antenna disposed on a second surface of the dielectric substrate and configured to receive the signal supplied from the waveguide by a first proximity coupling, and
a second antenna element disposed on the second surface of the dielectric substrate and configured to receive the signal supplied from the waveguide by a second proximity coupling; and
a transmission/reception unit configured to:
transmit a transmission signal with the antenna device, and
receive a reception signal with the antenna device.

20. A vehicle control system comprising:
a radar device mounted on a vehicle, the radar device including
an antenna device including
a dielectric substrate,
a power supply line disposed on a first surface of the dielectric substrate,
a waveguide which transmits a signal fed from the power supply line in the dielectric substrate,
a first antenna disposed on a second surface of the dielectric substrate and configured to receive the signal supplied from the waveguide by a first proximity coupling, and
a second antenna element disposed on the second surface of the dielectric substrate and configured to receive the signal supplied from the waveguide by a second proximity coupling; and
a transmission/reception unit configured to:
transmit a transmission signal with the antenna device, and
receive a reception signal with the antenna device; and
a vehicle control unit configured to control an operation of the vehicle based on a sensing result of the radar device.
